(19) United States
(12) Patent Application Publication
(10) Pub. No.: US 2010/0231787 A1
(43) Pub. Date: Sep. 16, 2010

(54) SIGNAL PROCESSING METHOD AND DEVICE

(76) Inventors: Jin Ho KIM, Suwon-si (KR); Yoon Kyung Choi, Yongin-si (KR); Oh Kyong Kwon, Seoul (KR)

Correspondence Address: F. CHAU & ASSOCIATES, LLC, 130 WOODBURY ROAD, WOODBURY, NY, 11797, US

(21) Appl. No.: 12/722,184

(22) Filed: Mar. 11, 2010

(30) Foreign Application Priority Data
Mar. 13, 2009 (KR) 10-2009-0021412

(51) Int. Cl. H04N 9/47

(52) U.S. Cl. 348/503; 348/E09.033

(57) ABSTRACT

A signal processing method includes recovering a clock signal from a clock stream included in an input serial data stream, recovering at least one control signal from a data pattern included in the serial data stream based on the recovered clock signal, and recovering RGB data from an RGB data stream included in the serial data stream based on the recovered clock signal.

### CROSS-REFERENCE TO RELATED APPLICATIONS

This application claims priority to Korean Patent Application No. 10-2009-0021412, filed on Mar. 13, 2009, in the Korean Intellectual Property Office (KIPO), the disclosure of which is incorporated by reference herein.

### BACKGROUND

1. Technical Field

Embodiments of the inventive concept relate to signal processing, and more particularly, to a signal processing method of transmitting a clock signal and a data signal and a signal processing device using the method.

2. Discussion of Related Art

A display device that provides a diversity of functions with a large screen, a high resolution, and a high grayscale, needs to process a large amount of data quickly. Accordingly, there is a need for a high-speed interface that ensures the integrity of a signal and its transmission at high speeds in a display device.

A high-speed interface is needed not only for digital appliances such as wide televisions (TVs) or monitors of personal computers (PCs), but also for mobile terminals (e.g., a personal digital assistant (PDA), smartphone, etc.).

A less complex high-speed interface with fewer internal connections that meets the demands of a large screen, high resolution, and high scale may decrease the manufacturing cost of the display device. Further, a high-speed interface used within a mobile terminal is limited to the power reserves therein, which are typically small. Moreover, when data is transmitted at a high speed, the quality of data displayed may be reduced unless the high-speed interface is protected from electrical noise such as skew, jitter, reflection noise.

Thus, there is a need for a signal processing method and device that has less signal lines for transmitting data, consumes less power, and reduces electrical noise such as skew, jitter, or reflection noise that may occur while the data is transmitted at high speeds.

### SUMMARY

A signal processing method according to an exemplary embodiment of the inventive concept includes recovering a clock signal from a clock stream included in an input serial data stream, recovering at least one control signal from a data pattern included in the serial data stream based on the recovered clock signal, and recovering RGB data from an RGB data stream included in the serial data stream based on the recovered clock signal.

The clock stream may be received during a first line time of a frame. The method may further include parallelizing the RGB data according to a clock signal related with the recovered clock signal. For example, the trigger signal may be derived from dividing the recovered clock signal by a division factor in response to one of the at least one recovered control signals. The at least one control signal may include at least one of a vertical synchronizing signal, a horizontal synchronizing signal, and a data synchronizing signal.

A signal processing method according to an exemplary embodiment of the inventive concept includes generating a clock signal, encoding each of a plurality of control signals and generating a data pattern, generating a serial data stream including the clock signal, the data pattern, and RGB data, and converting the serial data stream using differential signaling to transmit the serial data stream using a pair of differential signal lines.

A signal processing device according to an exemplary embodiment of the inventive concept includes a clock signal generator configured to recover a clock signal from a serial data stream input using differential signaling and a recovery circuit configured to recover at least one control signal and RGB data from the serial data stream according to a recovered clock signal.

The recovery circuit may include a sampler configured to sample the serial data stream according to the recovered clock signal and to generate sampled data and a control signal generator configured to recover the at least one control signal and the RGB data from the sampled data. The signal processing device may further include a deserializer configured to deserialize recovered RGB data according to a clock signal related with the recovered clock signal.

A signal processing method of a transmitting unit and a receiving unit connected through differential signal lines is provided according to an exemplary embodiment of the inventive concept includes the transmitting unit generating a serial data stream including a clock signal, a data pattern in which at least one control signal is encoded, and RGB data, the transmitting unit transmitting the serial data stream to the receiving unit through the differential signal lines using differential signaling, and the receiving unit recovering the clock signal from a received serial data stream. The receiving unit recovers the at least one control signal and the RGB data from the received serial data stream according to the recovered clock signal.

A signal processing device according to an exemplary embodiment of the inventive concept includes a transmitting unit configured to generate a serial data stream including a clock signal, a data pattern in which at least one control signal is encoded, and RGB data, and a receiving unit configured to recover the clock signal from a received serial data stream and to recover the at least one control signal and the RGB data from the received serial data stream according to a recovered clock signal.

The signal processing device may further include a pair of differential signal lines configured to transmit the serial data stream generated by the transmitting unit to the receiving unit using differential signaling.

A signal processing device according to an exemplary embodiment of the inventive concept includes a timing controller, a clock signal generator, and a recovery circuit. The timing controller is configured to encode received video signals, control signals, and a reference clock signal into a frame of serial data. The timing controller is further configured to convert the frame into differential signals for output to a pair of signal lines. A first part of the frame includes the reference clock signal and subsequent parts of the frame include at least one of the control signals and red-green-blue (RGB) data of the video signals. The clock signal generator is configured to recover a clock signal from the differential signals. The recovery circuit is configured to recover at least one of the control signals and the RGB data from the differential signals according to the recovered clock signal.

### BRIEF DESCRIPTION OF THE DRAWINGS

The inventive concept will become more apparent by describing in detail exemplary embodiments thereof with reference to the attached drawings in which:

FIG. 1 is a schematic block diagram of a display device provided to explain a method of transmitting a signal according to an exemplary embodiment of the inventive concept;

FIG. 2 is a block diagram of a timing controller according to an exemplary embodiment of the inventive concept;

FIG. 3 shows an example of a serial data stream generated by the timing controller illustrated in FIG. 2 and a timing diagram of signals recovered from the serial data stream;

FIG. 4 is a detailed block diagram of a source driver integrated circuit (IC) according to an exemplary embodiment of the inventive concept;

FIG. 5 is a block diagram of a control signal generator illustrated in FIG. 4 according to an exemplary embodiment of the inventive concept;

FIG. 6 is a timing chart for explaining a method of recovering a signal from a serial data stream according to some embodiments of the inventive concept;

FIG. 7 is a block diagram of a system connecting a timing controller and a source driver using point-to-point differential signaling interface according to an exemplary embodiment of the inventive concept; and

FIG. 8 is a diagram of a mobile system according to an exemplary embodiment of the inventive concept.

### DETAILED DESCRIPTION OF EXEMPLARY EMBODIMENTS

The inventive concept will be described more fully hereinafter with reference to the accompanying drawings, in which exemplary embodiments thereof are shown. The inventive concept may, however, be embodied in many different forms and should not be construed as limited to the exemplary embodiments set forth herein. In the drawings, like numbers refer to like elements throughout. It will be understood that when an element is referred to as being “connected” or “coupled” to another element, it can be directly connected or coupled to the other element or intervening elements may be present.

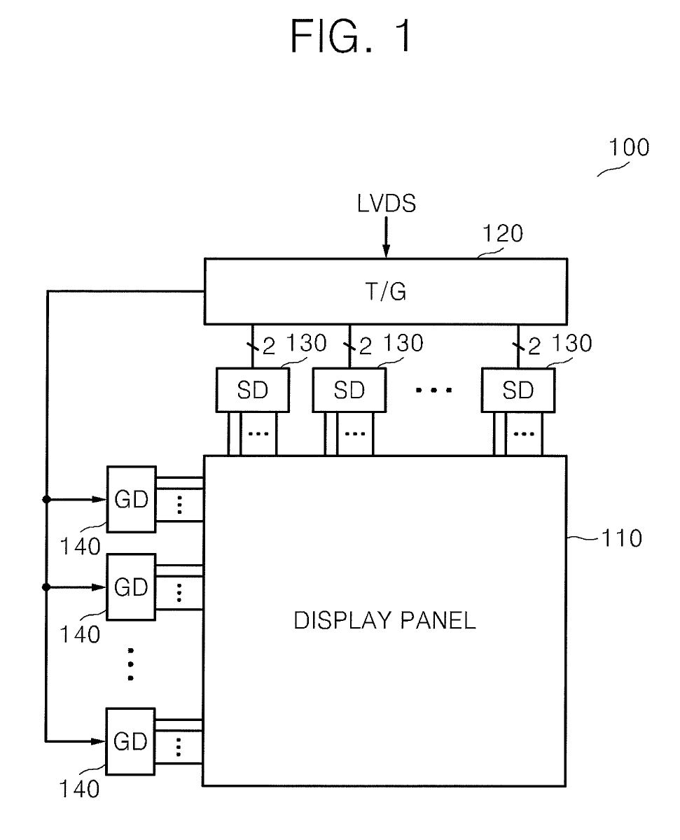

FIG. 1 is a schematic block diagram of a display device 100 provided to explain a method of transmitting a signal according to an exemplary embodiment of the inventive concept. Referring to FIG. 1, the display device (or a display system) 100 includes a display driving circuit and a display panel 110.

The display panel 110 displays an image according to driving signals, e.g., a clock signal and a plurality of control signals, and data signals, which are output from the display driving circuit. The display driving circuit or a display driver IC (DDI) provides the data signals and the driving signals to the display panel 110 for image display and may include a timing controller 120, at least one source driver IC 130 and at least one gate driver IC 140. The number of chips, e.g., source driver ICs 130 and gate driver ICs 140, included in the display driving circuit may vary with the size of the display panel 110 or the number of colors represented by the display panel 110. A source driver IC 130 is an example of a data line driving circuit.

The timing controller 120 converts an externally input video signal LVDS into a data signal, and generates a plurality of control signals (or driving signals) for controlling the operations of the source driver ICs 130 and the gate driver ICs 140. The data signal may include an N (e.g., a positive integer) bit RGB data stream. The timing controller 120 generates a serial data stream including a clock signal, a data pattern, and RGB data. The data pattern includes an encoded form of at least one of the plurality of control signals. The timing controller 120 converts the serial data stream into differential signals, and outputs each of the differential signals to one of the source driver ICs 130 through a pair of signals lines. Accordingly, the timing controller 120 may function as a transmitting unit for transmitting the serial data stream and each source driver IC 130 may function as a receiving unit for receiving the serial data stream. The transmitting unit and the receiving unit may be implemented in a single circuit or separate circuits, respectively.

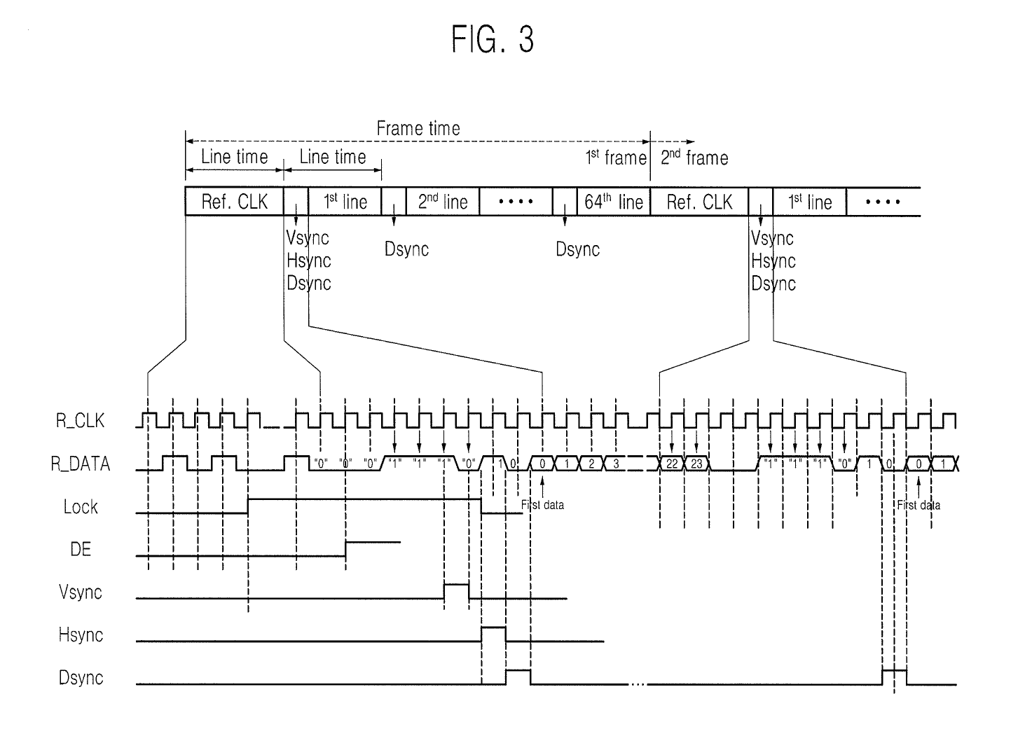

To reduce the number of signal lines, a pair of differential signal lines may be connected between the timing controller 120 and each source driver IC 130. The format of a serial data stream transmitted through the pair of signal lines may be determined by transmitter/receiver specifications defined by developers and will be described in more detail with reference to FIGS. 3 through 6 below.

A signal processing circuit, e.g., the source driver IC 130 may receive a serial data stream transmitted by the timing controller 120 using differential signaling and recover a clock signal, a plurality of control signals, and RGB data from the serial data stream. A gate driver IC 140 may sequentially drive gate lines included in the display panel 110 in response to at least one control signal output from the timing controller 120. The display panel 110 may display an image in response to driving signals output from the gate driver IC 140 and RGB data output from the source driver IC 130. The RGB data may be, for example, 6, 8, 10, 18, 24 or 30 bits in length. However, the size of the RGB data is not limited to any particular number of bits.

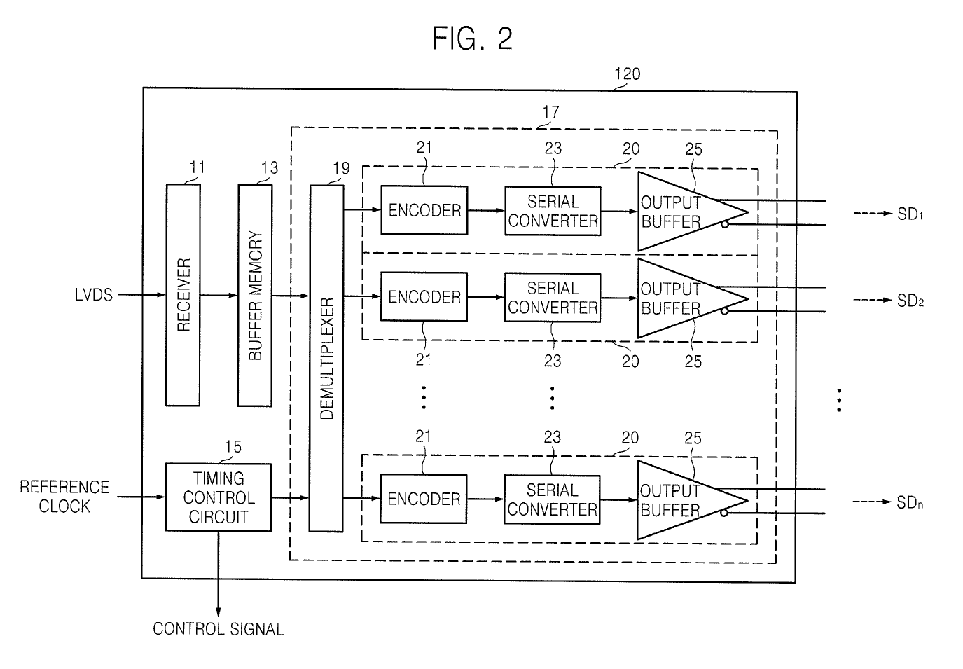

FIG. 2 is a block diagram of the timing controller 120 according to an exemplary embodiment of the inventive concept. Referring to FIG. 2, the timing controller 120 includes a receiver 11, a buffer memory 13, a timing control circuit 15, and a transmitter 17.

The receiver 11 receives externally input signals, for example, including video signals LVDS and control signals, and converts them into digital signals, e.g., a TTL or CMOS level signals, suitable to an internal circuit. The input signal may conform to low voltage differential signaling or a digital visual interface (DVI) signal. However, the input signal is not restricted to a certain signal format.

The buffer memory 13 temporarily stores and then outputs a signal received from the receiver 11. The timing control circuit 15 generates driving signals for driving each source driver IC 130 and each gate driver IC 140 and a clock signal used by the transmitter 17 based on control signals and a reference clock signal. Although FIG. 2 illustrates the reference clock signal being input from an external source, embodiments of the inventive concept are not limited thereto. For example, a clock signal recovered from an input signal input to the timing control circuit 15 may be used as the reference clock signal in an exemplary embodiment of the inventive concept.

The transmitter 17 includes a demultiplexer 19 and a plurality of source driving circuits 20. The demultiplexer 19 divides digital signals, for example video signals LVDS and/or control signals output from the buffer memory 13 into the source driving circuits 20. Each of the source driving circuits 20 includes an encoder 21, a serial converter 23, and an output buffer 25.

The encoder 21 converts video signals LVDS into data signals, e.g., an N-bit RGB data stream, and converts the control signals into a data pattern in which at least one of the control signals is encoded. The serial converter 23 generates a serial data stream including a clock signal, the N-bit RGB data stream, and the data pattern. The clock signal may be a signal that secures periodical transition of data to maintain the locking state of a clock signal recovered. The output buffer 25 converts the serial data stream output from the serial converter 23 into differential signals SD₁, SD₂, . . . , or SDₙ and outputs the differential signals SD₁, SD₂, . . . , or SDₙ to a corresponding one of the source driver ICs 130 through a pair of signal lines.

FIG. 3 shows an example of a serial data stream generated by the timing controller 120 illustrated in FIG. 2 and a timing diagram of signals recovered from the serial data stream. FIG. 3 shows an example of a communication protocol that may be used by the display device 100.

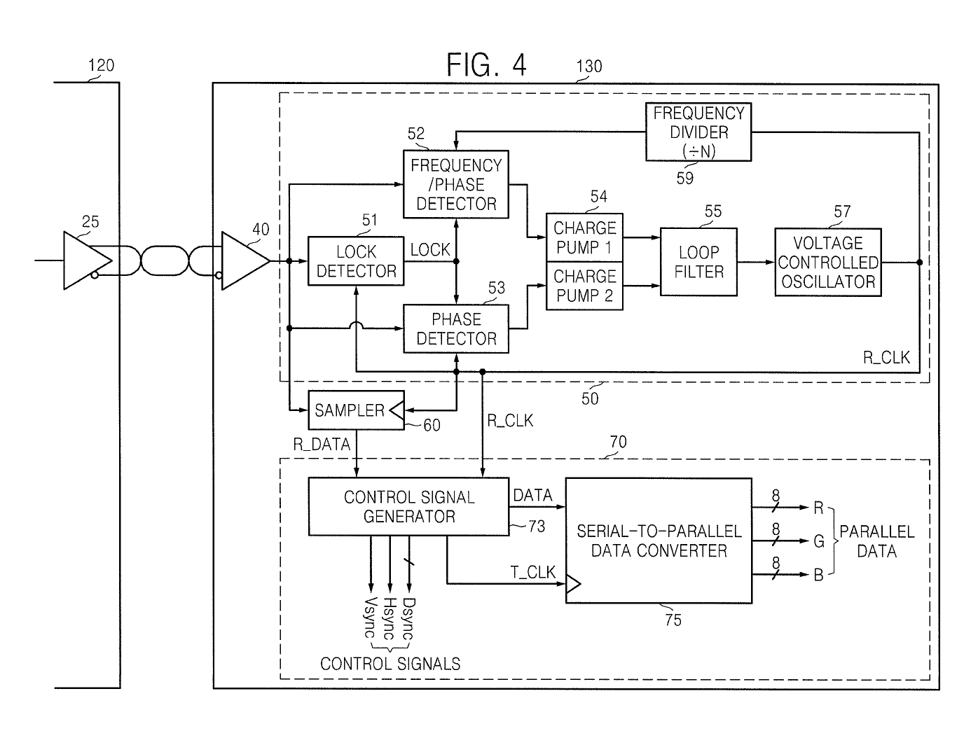

The timing controller 120 may generate and output a serial data stream enabling display of an image on the display panel 110 in units of frames. A frame time during which a single frame is output may be determined according to the resolution of the display panel 110. The timing controller 120 may generate and output a clock stream Ref.CLK during a first line time. A clock signal generator (e.g., clock signal generator 50 in FIG. 4) of each source driver IC 130 may recover a clock signal R_CLK from the clock stream Ref.CLK.

When the timing controller 120 outputs the clock stream Ref.CLK every time a frame starts, the clock signal generator 50 of each source driver IC 130 may update information used to recover the clock signal R_CLK at each frame and thus maintain a locking state.

Thereafter, the timing controller 120 may output a serial data stream including a data pattern and an RGB data stream at each line time. For example, during a second line time, the timing controller 120 may generate and output a first serial data stream including a first data pattern and a first RGB data stream (e.g., a first line). During a third line time, the timing controller 120 may generate and output second serial data including a second data pattern and a second RGB data stream (e.g., a second line). This process may repeat for each line of the frame, for example, during a 65th line time, the timing controller 120 may generate and output a 64th serial data stream including a 64th data pattern and a 64th RGB data stream (e.g., a 64th line). While FIG. 3 shows a frame including 64 lines, this is merely an example, as a frame may include a fewer or greater number of lines.

Data patterns included in different serial data streams may be the same or different from each other. Each data pattern may include a plurality of bits. Each data pattern may include a plurality of bits representing at least one encoded control signal.

Each source driver IC 130 may decode the first data pattern included in the first serial data stream and thus recover a plurality of control signals, e.g., a horizontal synchronizing signal Hsync, a vertical synchronizing signal Vsync, and a data synchronizing signal Dsync. Also, each source driver IC 130 may recover first image data from the first RGB data stream (e.g., the first line, included in the first serial data stream).

Each source driver IC 130, for example, a control signal generator (e.g., control signal generator 73 in FIG. 4) may decode a data pattern included in each serial data stream except the first serial data stream and recover a single control signal (e.g., the data synchronizing signal Dsync), two control signals (e.g., the horizontal synchronizing signal Hsync and the data synchronizing signal Dsync), or three control signals (e.g., the vertical synchronizing signal Vsync, the horizontal synchronizing signal Hsync and the data synchronizing signal Dsync). For example, when the control signal generator 73 detects the pattern “00111010” from the data pattern included in the first serial data stream while a lock signal Lock is at a high level, as illustrated in FIG. 3, the source driver IC 130 may sequentially generate or recover the vertical synchronizing signal Vsync, the horizontal synchronizing signal Hsync, and the data synchronizing signal Dsync. The detected pattern is not limited to “00111010”, as the detected pattern may vary in alternate embodiments.

FIG. 4 is a block diagram of the source driver IC 130 according to an exemplary embodiment of the inventive concept. Referring to FIGS. 3 and 4, the source driver IC 130 includes an input buffer 40, a clock and data recovery circuit, and a serial-to-parallel data converter 75. For clarity of the description, FIG. 4 shows only an interface receiving terminal in the source driver IC 130.

The input buffer 40 may convert differential signals corresponding to a serial data stream output from the timing controller 120 into a single-level signal and output the single-level signal. The input buffer 40 may recover a CMOS-level digital signal suitable to an internal circuit of the source driver IC 130 from the received serial data stream.

The clock and data recovery circuit includes a clock signal generator 50, a sampler 60, and a control signal generator 73. The sampler 60 and the control signal generator 73 may together form a recovery circuit.

The clock signal generator 50 includes a lock detector 51, a frequency/phase detector 52, a phase detector 53, a charge pump 54, a loop filter 55, and a voltage controlled oscillator 57. The clock signal generator 50 may recover the clock signal R_CLK from the single-level signal output from the input buffer 40. For example, the clock signal generator 50 may recover the clock signal R_CLK from the clock stream Ref.CLK.

While the clock signal generator 50 may be implemented by a delay locked loop (DLL) or a phase locked loop (PLL), embodiments of the inventive concept are not restricted thereto. The lock detector 51 may compare the phase of the single-level signal output from the input buffer 40 with the phase of a signal output from the voltage controlled oscillator 57, generate a lock signal Lock according to a result of the comparison, and control the operation of the frequency/phase detector 52 and the operation of the phase detector 53 based on the lock signal Lock.

The frequency/phase detector 52 may compare the phase of the single-level signal with the phase of the signal output from the voltage controlled oscillator 57 or the phase of a signal output from a frequency divider 59 in response to the lock signal Lock and output a first phase control signal to the charge pump 54 according to a result of the comparison. The phase detector 53 may compare the phase of the single-level signal with the phase of the signal output from the voltage controlled oscillator 57 in response to the lock signal Lock and output a second phase control signal to the charge pump 54 according to a result of the comparison.

The charge pump 54 may include a first charge pump and a second charge pump. The first charge pump may output a control voltage in response to the first phase control signal output from the frequency/phase detector 52 and the second charge pump may output a control voltage in response to the second phase control signal output from the phase detector 53. The loop filter 55 may filter the control voltages output from the charge pump 54 and output a filtered voltage to the voltage controlled oscillator 57. The loop filter 55 may be implemented by a low pass filter. The voltage controlled oscillator 57 may generate a signal having a frequency proportional to the filtered voltage output from the loop filter 55 and output the generated signal as the recovered clock signal R_CLK.

The frequency and/or phase of the clock signal R_CLK recovered by the clock signal generator 50 during the operation of the source driver IC 130 is different from the frequency and/or phase of the display device 100 shown in FIG. 1. The timing controller 120 may transmit the clock stream Ref.CLK to the source driver IC 130 during the first line time to synchronize the frequency and/or phase of the clock signal R_CLK with the frequency and/or phase of the display device 100.

During an initial stage of operation, a periodically toggling signal is applied to a receiving terminal (e.g., the source driver IC 130) to recover a clock signal, so that the output signal of the voltage controlled oscillator 57 or the frequency divider 59 is fed back to the frequency/phase detector 52 and locked to the single-level signal output from the input buffer 40. After the recovered clock signal R_CLK is locked to the single-level signal, the output signal of the voltage controlled oscillator 57 (e.g., the recovered clock signal R_CLK) can be used as an operating signal of the internal circuit. In addition, the recovered clock signal R_CLK is fed back to the phase detector 53, so that the phase of an output signal of the voltage controlled oscillator 57 is controlled to eliminate or reduce a phase difference between the single-level signal and the recovered clock signal R_CLK.

The clock signal generator 50 may optionally include the frequency divider 59. The frequency divider 59 may divide the recovered clock signal R_CLK output from the voltage controlled oscillator 57 by a division factor and generate a signal having a divided frequency. The frequency/phase detector 52 may compare the phase of the single-level signal output from the input buffer 40 with the phase of the signal output from the frequency divider 59 and output a first phase control signal to the charge pump 54 according to a result of the comparison.

The sampler 60 may sample a serial data stream according to the recovered clock signal R_CLK and transmit sampled data R_DATA to the control signal generator 73.

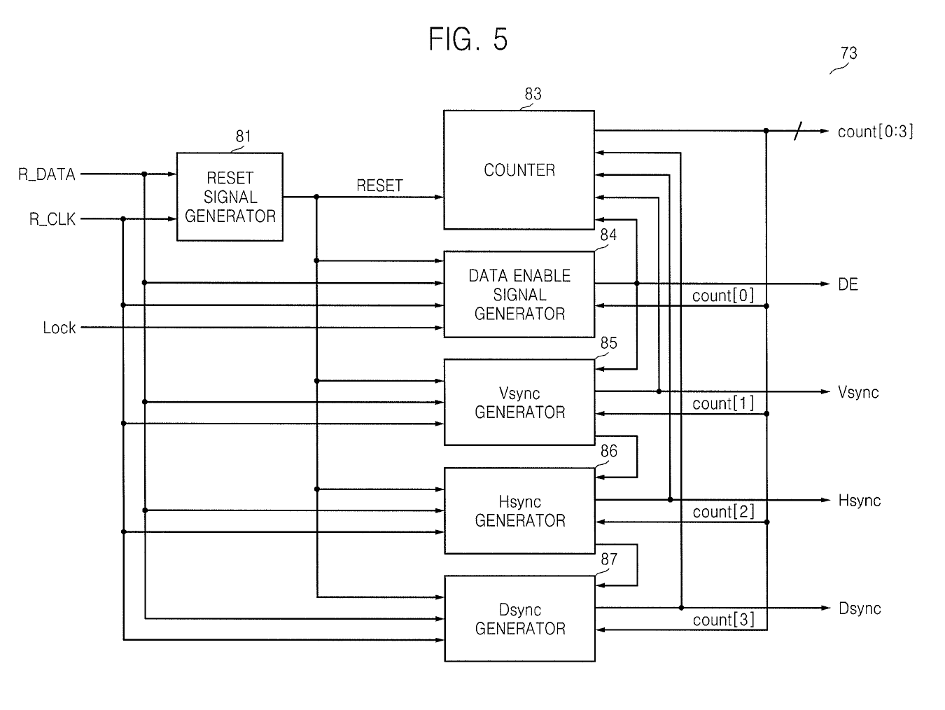

The control signal generator 73 may receive the sampled data R_DATA from the sampler 60 and the recovered clock signal R_CLK from the clock signal generator 50 and recover a plurality of control signals Vsync, Hsync, and Dsync and RGB data DATA from the sampled data R_DATA. In addition, the control signal generator 73 may divide the frequency of the recovered clock signal R_CLK by a division factor in response to the data synchronizing signal Dsync and output a frequency-divided signal to the serial-to-parallel data converter 75 as a trigger signal T_CLK. The control signal generator 73 will be described in more detail with reference to FIG. 5 later.

The serial-to-parallel data converter 75 may convert the RGB data stream DATA output from the control signal generator 73 into RGB parallel data in response to the trigger signal T_CLK and output the RGB parallel data. The serial-to-parallel data converter 75 is an example of a deserializer that performs parallelization.

According to at least one embodiment of the inventive concept, RGB parallel data can be recovered at a high speed in synchronization with the clock signal R_CLK recovered based on a data pattern included in a serial data stream or the system clock signal of a display device. In addition, the frequency and the phase of the clock signal R_CLK recovered based on a data pattern included in a serial data stream may be periodically adjusted to maintain the locking state, so that recovered RGB parallel data can be reliably output at a high speed and the influence of electromagnetic interference (EMI) and skew can be reduced or removed.

FIG. 5 is a block diagram of the control signal generator 73 illustrated in FIG. 4 according to an exemplary embodiment of the inventive concept. Referring to FIG. 5, the control signal generator 73 includes a reset signal generator 81, a counter 83, a data enable signal generator 84, a vertical synchronizing signal (Vsync) generator 85, a horizontal synchronizing signal (Hsync) generator 86, and a data synchronizing signal (Dsync) generator 87. The control signal generator 73 may have a different structure as that illustrated in FIG. 5 according to the number of control signals used to control the operation of the display panel 110. The control signal generator 73 will be described in more detail with reference to FIGS. 4 and 5 below.

The reset signal generator 81 generates a reset signal RESET based on the sampled data R_DATA output from the sampler 60 and the recovered clock signal R_CLK output from the clock signal generator 50 and initializes internal circuits of control signal generator 73 according to the reset signal RESET.

Thereafter, when at least two consecutive bits of the sampled data R_DATA has a high or low level without toggling for the first time while the recovered clock signal R_CLK is locked, the data enable signal generator 84 may determine that a training period for clock recovery has ended and output a data enable signal DE having a high level according to the determination result to indicate the input of data.

The Vsync generator 85 may output the vertical synchronizing signal Vsync based on the sampled data R_DATA input right after the data enable signal DE is generated (or enabled) and the recovered clock signal R_CLK. The Hsync generator 86 may output the horizontal synchronizing signal Hsync based on the sampled data R_DATA input right after the vertical synchronizing signal Vsync is generated (or enabled) and the recovered clock signal R_CLK. The Dsync generator 87 may output the data synchronizing signal Dsync based on the sampled data R_DATA input right after the horizontal synchronizing signal Hsync is generated (or enabled) and the recovered clock signal R_CLK.

The control signal generator 73 recognizes data input after the data synchronizing signal Dsync is generated (or enabled) as first data of a valid image data stream.

As illustrated in FIG. 3, when the control signal generator 73 detects data of “0011” for the first time in a locking state (e.g., when the Lock signal is enabled), the generator 73 generates the data enable signal DE indicating the input of data. When data of “1” is detected right after the generation of the data enable signal DE, that is, when the input data is “00111”, the control signal generator 73 generates the vertical synchronizing signal Vsync. When data of “0” is detected right after the vertical synchronizing signal Vsync is generated, that is, when the input data is “001110”, the control signal generator 73 generates the horizontal synchronizing signal Hsync. When data of “1” is detected right after the horizontal synchronizing signal Hsync is generated, that is, the input data is “0011101”, the control signal generator 73 generates the data synchronizing signal Dsync. Thereafter, when data of “0” is detected, that is, when the input data is “00111010”, the control signal generator 73 recognizes data input thereafter as first data of a valid RGB data stream.

The counter 83 counts the number of control signals generated in the internal circuit of the control signal generator 73 and outputs a count value COUNT[0:3].

Based on the count value COUNT[0:3], the control signal generator 73 may generate a control signal to be output next and also check whether the control signals have been being generated normally. For example, the control signal generator 73 may generate the horizontal synchronizing signal Hsync indicating a next line of data based on a first count value COUNT[3] corresponding to the generation of the data synchronizing signal Dsync and may generate the vertical synchronizing signal Vsync indicating the start of a next frame based on a second count value COUNT[2] corresponding to the generation of the horizontal synchronizing signal Hsync.

In addition, each of the data enable signal generator 84, the Vsync generator 85, the Hsync generator 86, and the Dsync generator 87 may transmit an enable signal to a next output terminal so that a next control signal is output.

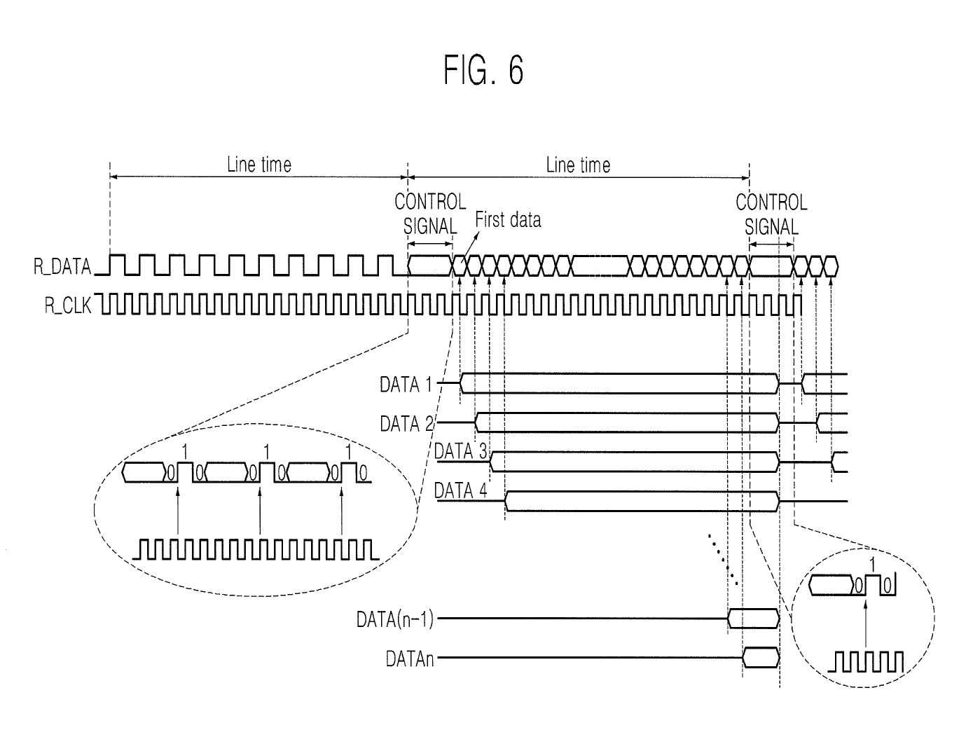

FIG. 6 is a timing chart for explaining a method of recovering a signal from a serial data stream according to an exemplary embodiment of the inventive concept. Referring to FIGS. 4 through 6, a procedure in which the source driver IC 130 recovers a clock signal from a serial data stream and recovers RGB data according to the recovered clock signal R_CLK is performed in the same manner as the procedure described with reference to FIG. 3. Thus, a detailed description thereof will be omitted. A procedure for recovering a control signal from the serial data stream according to an exemplary embodiment of the inventive concept will be described below.

The timing controller 120 may generate a data pattern including first bits representing one of a plurality of control signals and second bits distinguishing the first bits representing different control signals from each other. The data pattern may be inserted between RGB data streams.

For example, the second bits may be “010” and the timing controller 120 may encode the vertical synchronizing signal Vsync into “001”, the horizontal synchronizing signal Hsync into “110”, the data synchronizing signal Dsync into “011”, and dummy data into “000”. The timing controller 120 may generate a data pattern including first bits and second bits, for example, “001010”, “110010”, “011010”, or “000010”.

Consequently, the timing controller 120 may output a first serial data stream including a data pattern of “001010 110010 011010”, in which a plurality of control signals, i.e., the vertical synchronizing signal Vsync, the horizontal synchronizing signal Hsync, and the data synchronizing signal Dsync are encoded, and an RGB data stream to the source driver IC 130 during the first line time.

When the source driver IC 130 detects data of first bits input for the first time in the locking state, it generates a control signal corresponding to the first bits. Thereafter, while data of second bits is being input, the phase detector 53 compares the phase of a single-level signal with the phase of the recovered clock signal R_CLK and updates phase information of the output signal of the voltage controlled oscillator 57. In other words, even while a data input signal (e.g., a data pattern and an RGB data stream) are being input after locking is accomplished, the clock signal generator 50 periodically adjusts the phase using the data of second bits inserted in the data pattern, thereby maintaining the locking state.

The timing controller 120 may output a serial data stream including a data pattern of “011010”, in which the data synchronizing signal Dsync is encoded, and an RGB data stream to the source driver IC 130 during each line time from a second line time. In addition, the timing controller 120 may output a data pattern of “000010” indicating the end of a current frame to the source driver IC 130 after outputting the last serial data stream. However, the data pattern indicating the end of a current frame is not limited to a data pattern of “000010”, as other data patterns may be used in alternate embodiments.

Consequently, the source driver IC 130, as described with reference to FIG. 4, may decode a data pattern and thus recover at least one control signal among the vertical synchronizing signal Vsync, the horizontal synchronizing signal Hsync, and the data synchronizing signal Dsync. In addition, the source driver IC 130 may recover RGB data from an RGB data stream and transmit the recovered RGB data to the display panel 110. The display panel 110 may display an image according to the RGB data recovered by the source driver IC 130.

The source driver IC 130 may distinguish a plurality of control signals and an RGB data stream from one another using second bits toggling periodically.

As described above, according to at least one embodiment of the inventive concept, a data pattern is regularly inserted between RGB data streams, so that at least one control signal and an RGB data stream are distinguished from each other and an unlocking state is prevented from occurring due to the increase in length of a serial data stream.

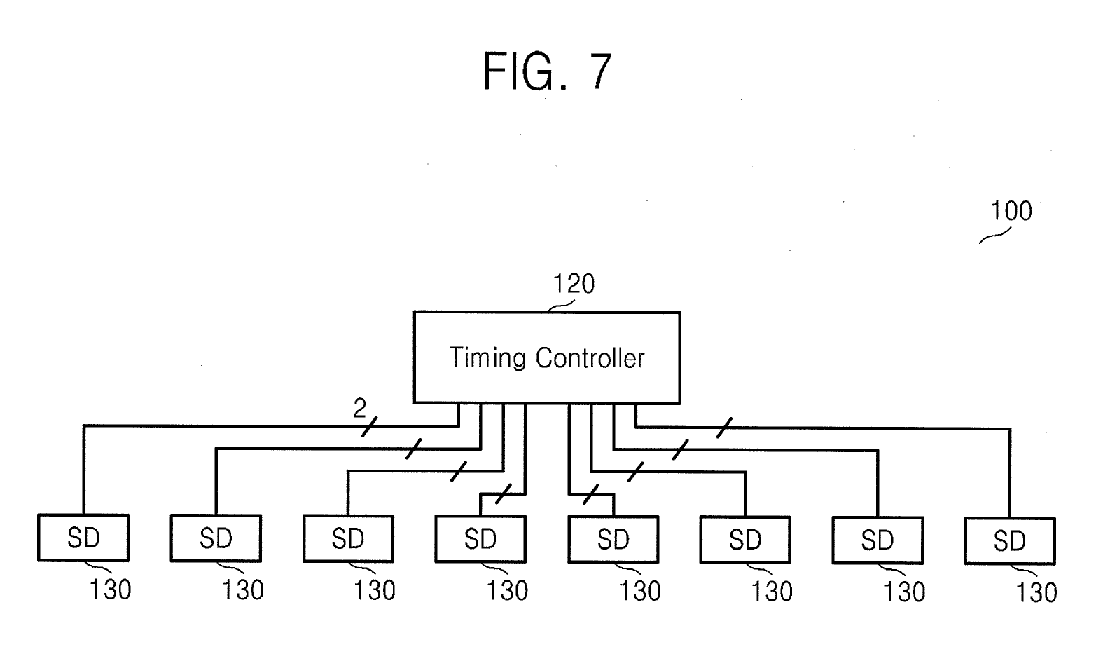

FIG. 7 is a block diagram of a system connecting a timing controller and a source driver using a point-to-point differential signaling (PPDS) interface according to an exemplary embodiment of the inventive concept. The system may be the display device 100 in which the timing controller 120 is connected with each source driver IC 130 through a pair of differential signal lines. The timing controller 120 may convert a clock signal, at least one control signal, and RGB data into a serial data stream and transmit the serial data stream to each source driver IC 130 using only pair of differential signal lines. Each source driver IC 130 may decode the serial data stream and recover the clock signal, the at least one control signal, and the RGB data.

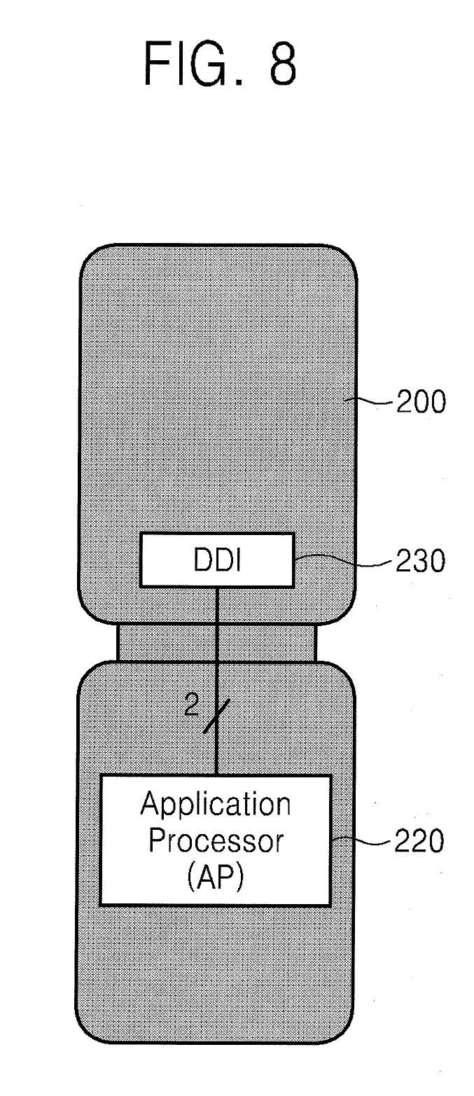

FIG. 8 is a diagram of a mobile system 200 according to an exemplary embodiment of the inventive concept. The mobile system 200 includes an application processor (AP) 220 and DDI 230. The AP 220 may include a transmitter and the DDI 230 may include a receiver. The AP 220 may be disposed in a lower portion of the mobile system 200 and the DDI 230 may be disposed in an upper portion of the mobile system 200. However, the positions of the AP 220 and DDI 230 are not limited thereto, as the AP 220 and DDI 230 may be located in various positions within the mobile system 200.

The AP 220 may transmit a serial data stream, in which a clock signal, at least one control signal (e.g., Vsync, Hsync, and Dsync), and RGB data are decoded, to the DDI 230 using only a pair of differential signal lines. The structure and the operations of the DDI 230 are substantially the same as those of the source driver IC 130 described with reference to FIGS. 1 through 4. As described with reference to FIG. 4, the DDI 230 may decode the serial data stream and recover the clock signal, the at least one control signal, and the RGB data.

The display device 100 and the mobile system 200 may use various types of interfaces according to a type of an application program used by the display device 100 and the mobile system 200 and a type of the display panel 110. For example, when the display device 100 illustrated in FIG. 1 has a medium or large size, the display device 100 may use reduced swing differential signaling (RSDS) interface, a point-to-point differential signaling (PPDS) interface, or advanced intra-panel interface (AiPi) to enable data to be communicated between the timing controller 120 and the source driver IC 130. The mobile system or mobile display device 200 may use a mobile display digital interface (MDDI) or mobile industry processor interface (MIPI) between the AP 220 and the DDI 230.

When a signal processing method according to at least one embodiment of the inventive concept is used, a transmitter, e.g., the timing controller 120 or the AP 220, transmits a serial data stream, in which a clock signal, at least one control signal, and RGB data are encoded or embedded, to the source driver IC 130 or the DDI 230 using only a pair of signal lines, and therefore, various peripheral devices using different interface methods can be unified in a single interface method. In addition, the number of signal lines used to communicate data is reduced in the display device 100, and therefore, the structure of the display device 100 is less complex and manufacturing cost may be reduced. Further, the display device 100 may reduce electrical noise such as skew, jitter, or reflection noise.

As described above, according to at least one embodiment of the inventive concept, since a data stream including a clock signal, a control signal, and data is transmitted using a pair of differential signal lines, the number of signal lines connected between a data receiving terminal and a data transmitting terminal may be reduced. Accordingly, the structure of a signal processing system is less complex, the influence of EMI may be reduced, and the influence of skew may be removed.

While the inventive concept has been particularly shown and described with reference to exemplary embodiments thereof, it will be understood by those of ordinary skill in the art that various changes in forms and details may be made therein without departing from the spirit and scope of the disclosure.

What is claimed is:

1. A signal processing method of a signal processing device comprising:
recovering a clock signal from a clock stream included in an input serial data stream;
recovering at least one control signal from a data pattern included in the serial data stream based on the recovered clock signal; and
recovering red-green-blue (RGB) data from an RGB data stream included in the serial data stream based on the recovered clock signal.

2. The method of claim 1, wherein the clock stream is received during a first line time of a frame.

3. The method of claim 1, further comprising parallelizing the RGB data according to a trigger signal, wherein the trigger signal is derived from dividing the recovered clock signal by a division factor in response to one of the at least one recovered control signals.

4. The method of claim 1, wherein the at least one recovered control signals comprises at least one of a vertical synchronizing signal, a horizontal synchronizing signal, and a data synchronizing signal.

5. The method of claim 1, wherein the serial data stream sequentially includes a plurality of parts, the first part including the clock stream, and the subsequent parts include the data pattern and the RGB data stream.

6. A signal processing device comprising:
a timing controller configured to encode received video signals, control signals, and a reference clock signal into a frame of serial data, the timing controller further configured to convert the frame into differential signals for output to a pair of signal lines, wherein a first part of the frame includes the reference clock signal and subsequent parts of the frame include at least one of the control signals and red-green-blue (RGB) data of the video signals;
a clock signal generator configured to recover a clock signal from the differential signals; and
a recovery circuit configured to recover at least one of the control signals and the RGB data from the differential signals according to the recovered clock signal.

7. The signal processing device of claim 6, wherein the recovery circuit comprises:
a sampler configured to sample the differential signals according to the recovered clock signal and to generate sampled data; and
a control signal generator configured to recover the at least one control signal and the RGB data from the sampled data.

8. The signal processing device of claim 7, wherein the control signal generator comprises:
a data enable signal generator (DEG) enabling a data enable signal (DE) upon determining that a training period for clock recovery has ended;
a Vsync generator (VG) enabling a vertical synchronizing signal (Vsync) after the DE has been enabled;
a Hsync generator (HG) enabling a horizontal synchronizing signal (Hsync) after the Vsync has been enabled; and
a Dsync generator (DG) enabling a data synchronizing signal (Dsync) after the Hsync has been enabled.

9. The signal processing device of claim 8, wherein the DEG determines that the training period has ended when at least two consecutive bits of the sampled data has a high level or a low level without toggling for the first time while the recovered clock signal is locked.

10. The signal processing device of claim 8, further comprising a counter that increments its count each time one of the De, Vsync, Hsync, Dsync is enabled, and the DEG, VG, HG, and DG receive the counter and enable their corresponding signals based on the count.

11. The signal processing device of claim 10, further comprising a reset signal generator generating a reset signal based on the sampled data and the recovered clock signal, wherein the reset signal initializes the counter, the DEG, the VG, the HG, and the DG.

12. The signal processing device of claim 6, further comprising a deserializer configured to deserialize the recovered RGB data according to a trigger signal derived from dividing the recovered clock signal by a division factor in response to one of the recovered control signals.

13. The signal processing device of claim 12, wherein the deserializer is a serial to parallel converter.

14. The signal processing device of claim 6, wherein the at least one control signal comprises at least one of a vertical synchronizing signal, a horizontal synchronizing signal, and a data synchronizing signal.

15. A signal processing device comprising:
a transmitting unit configured to generate a serial data stream including a clock signal, a data pattern in which at least one control signal is encoded, and RGB data; and
a receiving unit configured to recover the clock signal from the received serial data stream and to recover the at least one control signal and the RGB data from the received serial data stream according to the recovered clock signal.

16. The signal processing device of claim 15, further comprising a pair of differential signal lines configured to transmit the serial data stream generated by the transmitting unit to the receiving unit using differential signaling.

17. The signal processing device of claim 15, wherein the serial data stream sequentially includes a plurality of parts, the first part including the clock signal, and the subsequent parts include the data pattern and a part of the RGB data stream.

18. The signal processing device of claim 15, wherein the receiving unit further comprises:
a sampler configured to sample the differential signals according to the recovered clock signal and to generate sampled data; and
a control signal generator configured to recover the at least one control signal and the RGB data from the sampled data.

19. The signal processing device of claim 18, wherein the control signal generator comprises:
a data enable signal generator (DEG) enabling a data enable signal (DE) upon determining that a training period for clock recovery has ended;
a Vsync generator (VG) enabling a vertical synchronizing signal (Vsync) after the DE has been enabled;
a Hsync generator (HG) enabling a horizontal synchronizing signal (Hsync) after the Vsync has been enabled; and
a Dsync generator (DG) enabling a data synchronizing signal (Dsync) after the Hsync has been enabled.

20. The signal processing device of claim 18, wherein the DEG determines that the training period has ended when at least two consecutive bits of the sampled data has a high level or a low level without toggling for the first time while the recovered clock signal is locked.
